(19) United States
(12) Patent Application Publication
(10) Pub. No.: US 2008/0088985 A1
(43) Pub. Date: Apr. 17, 2008

(54) Magnetic head having CPP sensor with partially milled stripe height

(76) Inventors: Alexander Adrian Girling Driskill-Smith, Mountain View, CA (US); David John Seagle, Morgan Hill, CA (US)

Correspondence Address: INTELLECTUAL PROPERTY LAW OFFICES, 1901 SOUTH BASCOM AVENUE, SUITE 660, CAMPBELL, CA, 95008, US

(21) Appl. No.: 11/581,988

(22) Filed: Oct. 16, 2006

(51) Int. Cl. G11B 5/33; G11B 5/127

(52) U.S. Cl. 360/324.2

(57) ABSTRACT

A magnetic head including a CPP read head sensor. The CPP sensor includes a layered sensor stack including a free magnetic layer, a tunnel barrier layer, a pinned magnetic layer and an antiferromagnetic layer. An ion milling process is used to perform a partial depth material removal to establish the back wall of the sensor stack. The antiferromagnetic layer is not milled through to create the back wall of the sensor stack. Side walls of the sensor stack may also be created by ion milling, when the antiferromagnetic layer is not milled through in creating the side walls. In various embodiments, the material removal depth lies beyond the tunnel barrier layer, within or even through the pinned magnetic layer.

### BACKGROUND OF THE INVENTION

1. Field of the Invention

The present invention relates generally to read head portions of magnetic heads for hard disk drives and more particularly to current perpendicular to plane (CPP) tunnel junction read sensors for magnetic heads.

2. Description of the Prior Art

A computer disk drive stores and retrieves data by positioning a magnetic read/write head over a rotating magnetic data storage disk. The head reads from or writes data to concentric data tracks defined on surface of the disks. The heads are fabricated in structures called “sliders” and the slider flies above the surface of the disk on a thin cushion of air, where the surface of the slider which faces the disks is called an Air Bearing Surface (ABS).

Some recent read sensor structures use a tunnel junction sensor, also known as a “tunnel valve” for reading the magnetic field signals from the rotating magnetic data storage disk. The tunnel junction sensor typically includes a nonmagnetic tunnel barrier layer sandwiched between a pinned magnetic layer and a free magnetic layer. The pinned layer in turn is fabricated on an antiferromagnetic (AFM) pinning layer which fixes the magnetic moment of the pinned layer at an angle of 90 degrees to the air bearing surface (ABS). The magnetic moment of the free layer is free to rotate from a quiescent or zero bias point position in response to magnetic field signals from magnetic data bits written on the rotating magnetic disk. The tunnel junction sensor layers are typically disposed between first and second magnetic shield layers, where these first and second shield layers also serve as first and second electrical lead layers for conducting a sensor current through the device. The tunnel junction sensor is thus configured to conduct sensor current perpendicular to the planes (CPP) of the film layers of the sensor, as opposed to previously developed sensors where the sensor current is directed in the planes (CIP) or parallel to film layers of the sensor. The CPP configuration is attracting more attention recently, as it apparently can be made to be more sensitive than the CIP configuration, and thus is more useful in higher data density tracks and disks.

The read width and the stripe height of the sensor are significant well known parameters that refer to the width of the read head sensor stack and the height dimension of the sensor stack perpendicular to the ABS. Both of these dimensions are very important to the operating characteristics of the read head and they are typically defined using ion milling techniques. A problem that can occur in the fabrication of the prior art CPP sensors is that the ion milling can damage the tunnel barrier layer edges, which can cause unwanted reduction of electrical resistance and even electrical shorting of the tunnel barrier layer. Thus there is a need for a method of sensor fabrication which eliminates damage to the tunnel barrier layer when ion milling is used to shape sensor material stacks.

### SUMMARY OF THE INVENTION

The present invention includes a magnetic head having a CPP read head sensor. The CPP sensor includes a layered sensor stack including a free magnetic layer, a tunnel barrier layer, a pinned magnetic layer and an antiferromagnetic layer. An ion milling process is used to perform a partial depth material removal to establish the back wall of the sensor stack, where the antiferromagnetic layer is not milled through to create the back wall of the sensor stack. A partial ion milling may also be done at the side walls of the sensor, such that the antiferromagnetic layer is not milled in creating the side walls. The partial ion milling results in reduced damage to the milled edges of the tunnel barrier layer, and reduces the occurrence of unwanted electrical resistance reduction and electrical shorts across the edges of the tunnel barrier layer. In various embodiments, the material removal depth lies beyond the tunnel barrier layer, within or even through the pinned magnetic layer.

It is an advantage of the magnetic head of the present invention that there are reduced instances of electrical short circuits between the free magnetic layer and the pinned magnetic layer of the CPP read sensor.

It is another advantage of the magnetic head of the present invention that there are reduced instances of damage to the edge of the tunnel barrier layer which causes reduced electrical resistance or electrical short circuits between the free magnetic layer and the pinned magnetic layer of the CPP read sensor.

It is an advantage of a hard disk drive of the present invention that it includes the magnetic head of the present invention having reduced instances of electrical short circuits between the free magnetic layer and the pinned magnetic layer of the CPP read sensor.

It is another advantage of a hard disk drive of the present invention that it includes the magnetic head of the present invention having reduced instances of damage to the edge of the tunnel barrier layer which causes reduced electrical resistance or electrical short circuits between the free magnetic layer and the pinned magnetic layer of the CPP read sensor.

It is an advantage of the method for manufacturing a magnetic head of the present invention that the amount of material removed in the sensor stack milling process is reduced.

It is a another advantage of the method for manufacturing a magnetic head of the present invention that the total milling time is shorter.

It is a further advantage of the method for manufacturing a magnetic head of the present invention that manufacturing yields are improved since there are reduced yield losses due to electrical shorting between the free magnetic layer and the pinned magnetic layer.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 is a top plan view depicting a hard disk drive of the present invention having a magnetic head of the present invention;

FIG. 2 is a top plan view of a sensor stripe of a CPP read head portion of a prior art magnetic head;

FIG. 3 is a side elevational view of a prior art CPP read sensor, taken from the air bearing surface along lines 3-3 of FIG. 2;

FIG. 4 is a side cross-section view of the sensor layers deposited in fabricating the prior art CPP read sensor depicted in FIGS. 2 and 3;

FIG. 5 is a top plan view of a milling mask used in fabricating the prior art CPP sensor depicted in FIGS. 3 and 4;

FIG. 6 is a side cross-sectional view of the device depicted in FIG. 5, taken along lines 6-6 of FIG. 5;

FIG. 7 is an enlarged view of a portion 7 of the device depicted in FIG. 6;

FIG. 8 is a side cross-sectional view of a further fabrication step of the device depicted in FIG. 7;

FIG. 9 is a top plan view of a further milling mask used in fabricating the device depicted in FIGS. 2 and 3;

FIG. 10 is a side cross-sectional view of the device depicted in FIG. 9, taken along lines 10-10 of FIG. 9;

FIG. 11 is an enlarged view of a portion 11 of the device depicted in FIG. 10;

FIG. 12 is a side cross-sectional view of a further fabrication step of the device depicted in FIG. 11;

FIG. 13 is a side cross-sectional view of the completed prior art CPP sensor as depicted in FIGS. 2 and 3;

FIG. 14 is a side cross-sectional view of the sensor layers deposited in fabricating the CPP sensor of a magnetic head of the present invention;

FIG. 15 is a top plan view of a first milling mask used in fabricating the CPP sensor of the present invention;

FIG. 16 is a top plan view of a second milling mask used in fabricating the CPP sensor of the present invention;

FIG. 17 is a side cross-sectional view of a fabrication step for the CPP sensor of the present invention, taken along lines 17-17 of FIG. 16;

FIG. 18 is an enlarged view of a portion 18 of the device depicted in FIG. 17;

FIG. 19 is a side cross-sectional view of a further fabrication step of the CPP sensor of the present invention as depicted in FIG. 18;

FIG. 20 is a top plan view depicting another milling mask used in fabricating the CPP sensor of the present invention;

FIG. 21 is a side cross-sectional view of the device depicted in FIG. 20, taken along lines 21-21 of FIG. 20;

FIG. 22 is an enlarged view of a portion 22 of the device depicted in FIG. 21;

FIG. 23 is a side cross-sectional view depicting a further fabrication step of the CPP sensor of the present invention; and

FIG. 24 is a side cross-sectional view depicting a completed CPP sensor of the present invention that is part of a magnetic head of the present invention.

### DETAILED DESCRIPTION OF THE PREFERRED EMBODIMENTS

FIG. 1 is a top plan view that depicts significant components of a hard disk drive 10 of the present invention which includes the magnetic head of the present invention. The hard disk drive 10 includes a magnetic hard disk 12 that is rotatably mounted upon a motorized spindle 14. An actuator arm 16 is pivotally mounted within the hard disk drive 10 with a magnetic head 154 of the present invention disposed upon a distal end 22 of the actuator arm 16. A typical hard disk drive 10 may include a plurality of disks 12 that are rotatably mounted upon the spindle 14 and a plurality of actuator arms 16 having a plurality of magnetic heads 154 mounted upon the distal ends 22 of the plurality of the actuator arms 16. As is well known to those skilled in the art, when a hard disk drive is operated, the hard disk 12 rotates upon the spindle 14 and the magnetic head acts as an air bearing slider that is adapted for flying above the surface of the rotating disk. The slider includes a substrate base upon which various layers and structures that form the magnetic head are fabricated. Such heads are fabricated in large quantities upon a wafer substrate and subsequently sliced into discrete magnetic heads.

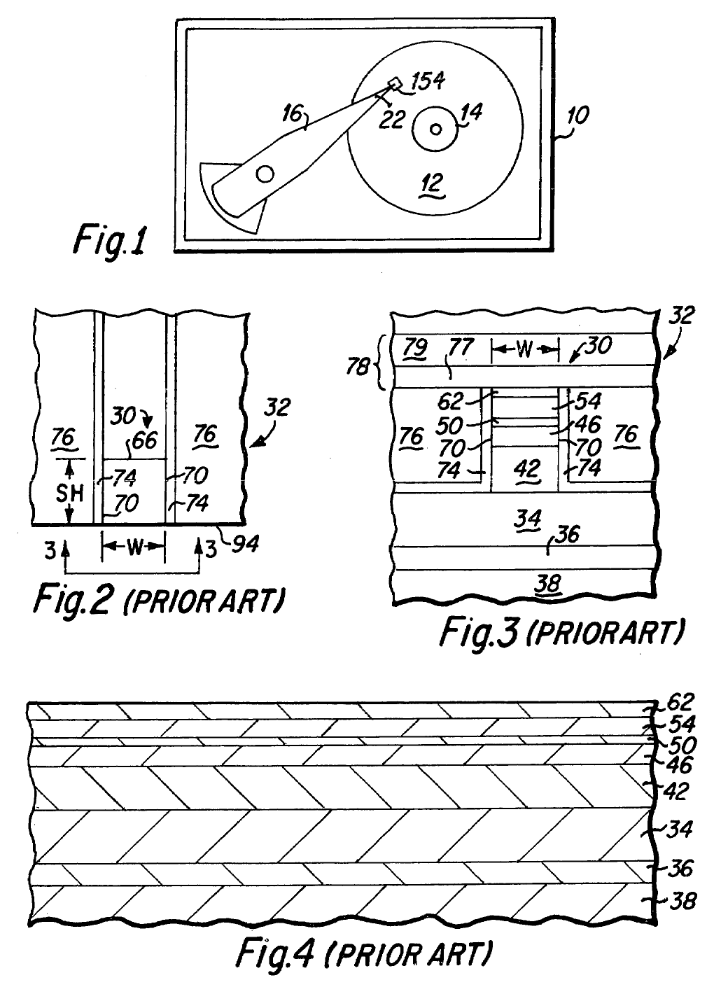

A typical prior art magnetic head will include both a read head portion and a write head portion. The read head portion is utilized to read data that has been written upon the hard disk 12, and the write head portion is utilized to write data to the disk 12. Prior art read head sensors are generally of two types, current-in-plane (CIP) and current-perpendicular-to-plane (CPP) as is well known to those skilled in the art. The present invention is directed to the read head portion of a magnetic head, and particularly to such read heads that include a CPP sensor, which includes sensors having a tunnel barrier structure, as is next described with aid of FIGS. 2 and 3.

FIG. 2 is a top plan view depicting the tunnel barrier sensor portion 30 of a prior art magnetic head 32, and FIG. 3 is a side elevational view of the tunnel barrier sensor 30 depicted in FIG. 2, taken from the air bearing surface of the magnetic heat 32 along lines 3-3 of FIG. 2. As is best seen in FIG. 3, the tunnel barrier sensor 30 includes a plurality of thin film layers. These layers include a first magnetic shield layer 34 that is fabricated upon an electrical insulation layer 36 that is deposited upon a wafer substrate 38. While many different layered sensor structures are known in the prior art, a typical sensor layer structure will include an antiferromagnetic layer 42 that is fabricated upon the first magnetic shield layer 34 and which may be comprised of PtMn. A pinned magnetic layer 46 is fabricated upon the antiferromagnetic layer 42, and it may be comprised of a magnetic material such as CoFe. Thereafter, a tunnel barrier layer 50 is fabricated upon the pinned magnetic layer 46, where the tunnel barrier layer 50 is composed of an electrical insulation material such as Al₂O₃. A free magnetic layer 54 is then fabricated upon the tunnel barrier layer 50, where the free magnetic layer 54 may be composed of a magnetic material such as CoFe or NiFe. Thereafter, a cap layer 62 is typically fabricated upon the free magnetic layer 54, and a typical cap layer may be comprised of a material such as tantalum. The layers 42-62 are then masked and ion milled in a plurality of steps to create a central sensor stack having a back wall 66 and side walls 70. As seen in the top plan view of FIG. 2, the distance W between the side walls 70 of the sensor 30 defines the read width of the sensor. In fabricating the sensor structure 30, the back wall 66 of the sensor layer is typically established prior to the fabrication of the side walls 70 as is described in greater detail herebelow.

Following the ion milling steps for creating the back wall 66 and side walls 70, a thin layer of electrical insulation 74 is next deposited upon the device, including the side walls 70. Thereafter, magnetic hard bias elements 76, typically composed of a material such as CoPtCr, are fabricated upon the insulation layer 74 proximate the side walls 70. A second magnetic shield structure 78, which may typically include a non-magnetic material layer 77 and a magnetic material layer 79, is then fabricated upon the cap layer 62 and hard bias elements 76. In fabricating the magnetic head 32, following the fabrication of the read head structures, and following subsequent fabrication steps to create write head structures (not shown), an air bearing surface (ABS) 94 is created. The distance between the ABS 94 and the back wall 66 is termed the stripe height (SH) of the sensor.

In an alternative CPP magnetic head design (not shown), an in-stack magnetic bias layer is fabricated upon the free magnetic layer to provide a biasing magnetic field for the free magnetic layer, where the hard bias elements 76 are then not required. Such alternative magnetic heads are known in the prior art and are within the contemplation of the present invention, as will be understood upon a complete reading of this description.

A magnetic head including a tunnel barrier sensor 30 operates by the passage of electrical sensor current from the first magnetic shield 34, through the sensor layers 42-62 and into the second magnetic shield 78, such that the current travels perpendicular to the planes (CPP) of the layers 42-62. The electrical insulation layer 74 serves to guide the sensor current through the sensor layers. The electrical properties of the tunnel barrier sensor are primarily a function of the material, area and thickness of the tunnel barrier layer 50, where the barrier layer area is determined by the product of the read width (W) and the stripe height (SH). The electrical resistance of the tunnel barrier layer material 50 controls the electrical resistance of the sensor 30, as the other layers of the sensor 30 are comprised of low resistance metallic materials. That is, the tunnel barrier layer material is comprised of an electrical insulator such as alumina, and the layer 50 is sufficiently thin (approximately 1 nanometer) that electrons carrying the sensor electrical current can tunnel through it. The operational characteristics of tunnel barrier sensors are well known to those skilled in the art, and a more detailed description thereof is not deemed necessary in order to fully describe the features of the present invention.

A problem of undesirable electrical resistance reduction and even electrical shorting of tunnel barrier sensors has arisen in CPP sensor read heads. The inventors have determined that this reduced electrical resistance and shorting problem occurs at the edges of the tunnel barrier layer 50, and the problem is apparently due to damage that occurs to the edges of the tunnel barrier layer when the sensor back wall 66 and side walls 70 are created. In order to more fully understand the nature of this problem, and the features of the present invention which alleviate this problem, a more detailed description of the fabrication steps of the prior art sensor 30 is next presented. The novel features of the present invention are thereafter described.

Referring to the side cross-sectional view of FIG. 4, in a first series of fabrication steps of the prior art tunnel barrier sensor 30, the insulation layer 36 is deposited upon the wafer substrate 38 and the first magnetic shield 34 is fabricated upon the insulation layer 36. Thereafter, the series of sensor layers, including the antiferromagnetic layer 42, pinned magnetic layer 46, tunnel barrier layer 50, free magnetic layer 54, and cap layer 62 are deposited sequentially across the surface of the wafer.

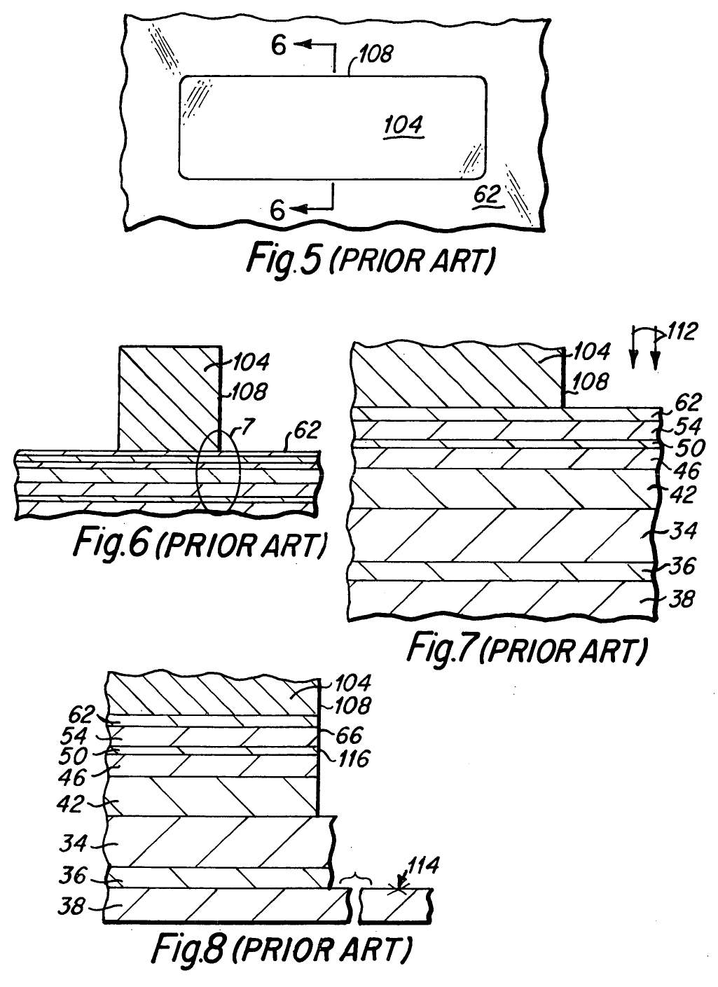

Thereafter, as depicted in FIGS. 5 and 6, a first milling mask 104 is fabricated upon the sensor layers. Such a mask 104 is simply depicted as a rectangle in the top view of FIG. 5 and in cross section in FIG. 6 which is taken along lines 6-6 of FIG. 5, although a typical prior art mask 104 may have a more complex shape. Significantly, the mask 104 is fabricated with a rear mask edge 108 that is disposed in the desired location of the back wall 66 that serves to define the stripe height of the sensor. An ion milling step using an ion beam 112 is next performed to remove sensor layer material that is not masked, and FIG. 7 is an enlarged view of a portion of FIG. 6 that is useful in depicting the ion milling using the ion beam 112, as is next shown in FIG. 8. Particularly, as is depicted in FIG. 8, the ion milling at the masking edge 108 results in the removal of the sensor layers 42-62 down to the first magnetic shield 34. Two significant features of this milling step are that the back wall 66 of the sensor is created, and significantly, the alignment marks 114 at various locations on the surface of the wafer substrate are uncovered. These alignment marks 114 are necessary to accurately position further milling masks, and the alignment marks become covered when the thin film sensor layers 42-62 are deposited across the surface of the wafer.

The tunnel barrier electrical resistance reduction and shorting problem is initially created during this first ion milling step. Particularly, the inventors hereof have determined that the prolonged exposure of the rear edge 116 of the tunnel barrier layer 50 to the ion milling process that includes the milling of the pinned magnetic layer 46 and the antiferromagnetic layer 42 results in an alteration of the electrical resistance of the tunnel barrier layer at its edge 116. That is, the electrical resistance at the edge 116 of the tunnel barrier layer 50 may become significantly reduced, and even electrically shorted during the prolonged ion milling process, as it is performed to remove the pinned magnetic layer 46 and the antiferromagnetic layer 42 in order to expose the wafer's alignment marks. As is described herebelow, in the present invention the ion milling of the sensor back wall 66 is reduced in depth and time duration, and the damage to the edge 116 of the tunnel barrier layer 50 is significantly reduced.

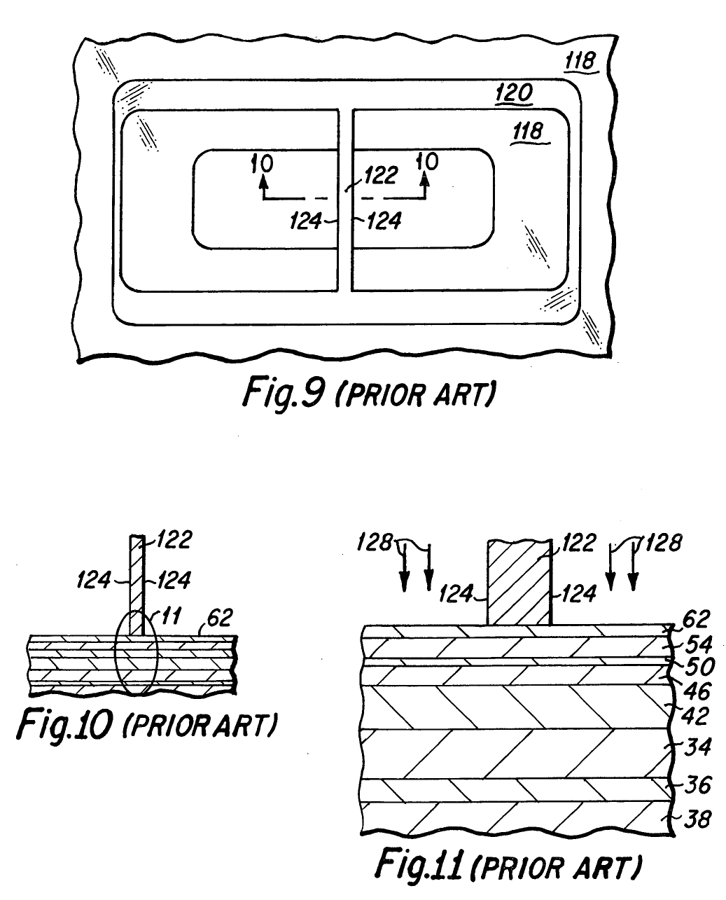

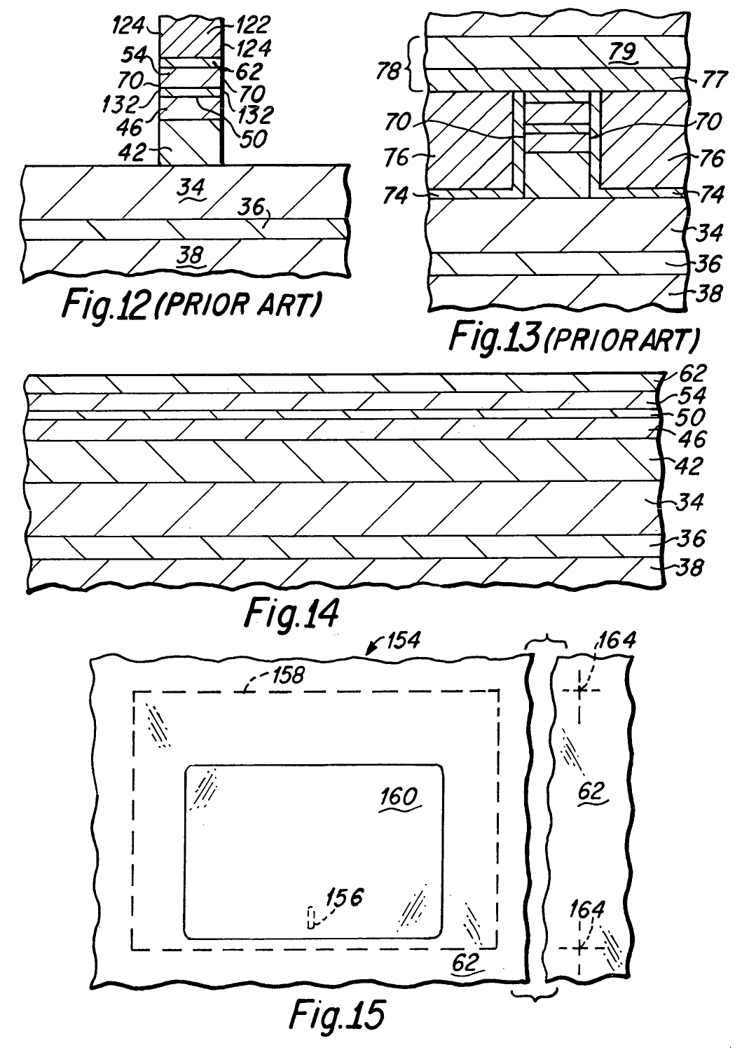

As is next depicted in the top plan view of FIG. 9 and the side elevational view of FIG. 10 (where FIG. 10 is a cross-sectional view taken along lines 10-10 of FIG. 9), a patterned fill layer 118, using a material such as alumina, is deposited upon the wafer. Thereafter, another milling mask 120 is fabricated upon the sensor layers. As is seen in FIGS. 9 and 10, the milling mask 120 includes a narrow central mask portion 122 having side edges 124; and for ease of understanding, FIG. 11 is an enlarged view of the mask portion 122 shown in FIG. 10. Referring to FIGS. 11 and 12, another ion milling step using an ion beam 128 is performed to remove unmasked sensor layer material down to the first magnetic shield 34. As is shown in FIG. 12, the side edges 124 of the mask 122 serve to create the milled sensor side walls 70 that define the read width of the sensor, as has been described hereabove with the aid of FIGS. 2 and 3. Once again, the extensive milling of the sensor layers, including the removal of the pinned magnetic layer material 46 and antiferromagnetic layer material 42, results in unwanted damage to the side edges 132 of the tunnel barrier layer 50. As was described hereabove, the milling damage to the side edges 132 of the tunnel barrier layer 50 can result in significantly reducing the electrical resistance of the tunnel barrier layer, including the creation of an electrical short across the tunnel barrier layer at the side edges 132.

Thereafter, as depicted in FIG. 13, a thin electrical insulation layer 74 is deposited upon the device, which also covers the side walls 70 of the remaining sensor material. The insulation layer 74 may be fabricated using atomic layer deposition (ALD) techniques, as are known to those skilled in the art. Thereafter, the hard bias elements 76 are fabricated upon the insulation layer 74 and the second magnetic shield structure 78, which may include a non-magnetic material layer 77 and a magnetic material layer 79, is fabricated above the sensor layers and hard bias elements 76.

The present invention seeks to resolve the tunnel barrier electrical resistance reduction and shorting problem by reducing the ion milling of the sensor layers; particularly, reduced milling at the back edge 116, as well as reduced milling at the side edges 132 of the tunnel barrier layer 50. The initial fabrication steps for the tunnel barrier sensor of the magnetic head 154 of the present invention are similar to those of the prior art and similar structures identically numbered for ease of comprehension. Particularly, as depicted in FIG. 14, the first magnetic shield 34 is fabricated upon the insulation layer 36 that is deposited upon the wafer substrate 38. Thereafter, the sensor layers, which may include an antiferromagnetic layer 42, a pinned magnetic layer 46, tunnel barrier layer 50, free magnetic layer 54, and cap layer 62 are deposited across the surface of the wafer. Significantly, as described hereabove, when the sensor layers are deposited they obscure the wafer alignment marks. It is necessary to reveal the wafer alignment marks in order to fabricate the sensor.

As is next depicted in the top plan view of FIG. 15, a first milling mask 160 is fabricated upon the surface of the cap layer 62. The first milling mask 160 is generally depicted as a rectangle in FIG. 15, and a significant feature of the mask 160 is that the wafer alignment marks 164 are not covered by the mask 160, where the alignment marks have been covered by the layers 42-62. Additionally, the milling mask 160 is smaller than the outline of the outer edges 158 of the magnetic head 154 although it covers the area 156 (shown in phantom) in which the sensor of the present invention will be fabricated. Thereafter, a first ion milling step of the present invention is performed in which the sensor layers 42-62 are removed in unmasked areas of the wafer to reveal the wafer alignment marks 164. Significantly, all of the sensor layers 42-62 are removed at the unmasked outer edges 158 of the magnetic head 154. This prevents metallic layers, particularly the PtMn antiferromagnetic layer, from undesirable exposure at the side edges of a completed magnetic head 154, which can lead to unwanted corrosion at the edges of a completed magnetic head if the PtMn layer is exposed.

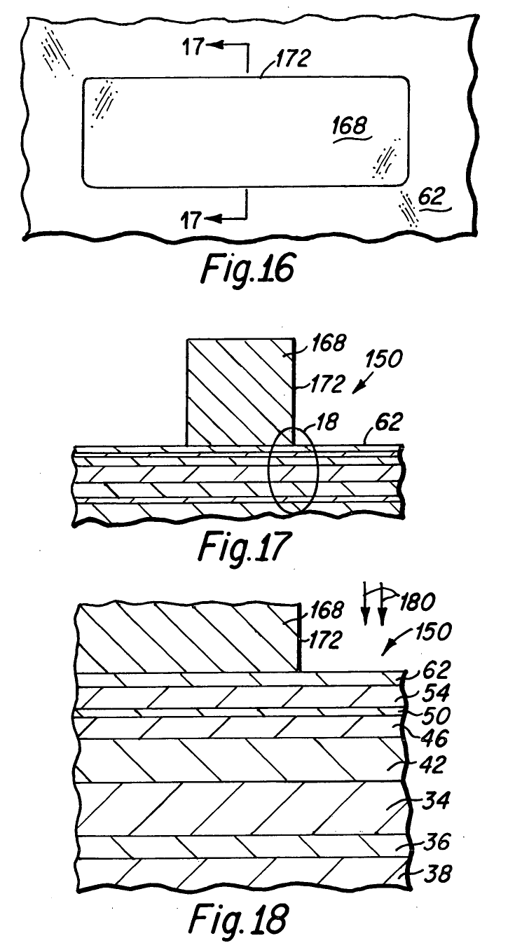

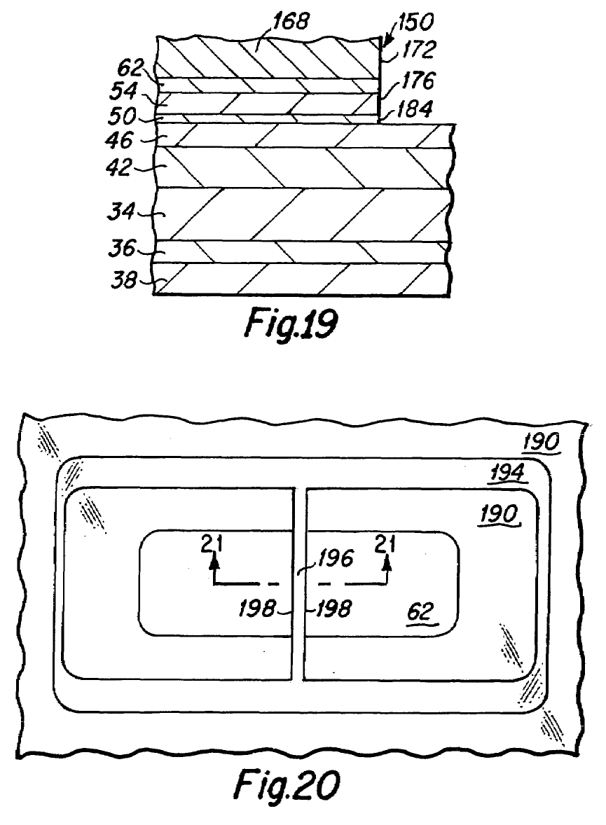

Thereafter, as depicted in FIGS. 16 and 17, the first milling mask 160 is removed and a second milling mask 168 is fabricated upon the surface of the cap layer 62 of the sensor layers. The second milling mask 168 may be identical to the prior art milling mask 104 depicted in FIGS. 5 and 6 and described hereabove. This milling mask 168 includes a back edge 172 that is positioned to establish the back wall 176 of the tunnel barrier sensor 150 of the present invention that establishes the stripe height of the sensor. For ease of understanding, FIG. 18 is an enlarged view of the back edge 172 of the mask 168 upon the sensor layers. Thereafter, as depicted in FIGS. 18 and 19, an ion milling step using an ion beam 180 is performed to remove unmasked sensor material. Significantly, this ion milling step is performed to remove sensor layers only down through the tunnel barrier layer 50. The pinned magnetic layer material 46 and the antiferromagnetic layer material 42 are not milled away. In comparison with the prior art sensor fabrication, as described hereabove with the aid of FIGS. 7 and 8, it is not necessary in the present invention to mill away the pinned magnetic layer 46 and antiferromagnetic layer 42 in order to expose the wafer alignment marks 164, because in the present invention the wafer alignment marks 164 have already been exposed in the previous milling step that is performed using the first milling mask 160, as described above with the aid of FIG. 15. Therefore, Applicant's second milling step which forms the rear edge 184 of the tunnel barrier layer 50 does not require the removal of the pinned magnetic layer 46 and antiferromagnetic layer 42 to expose the wafer alignment marks 164. Thus, in Applicant's sensor 150, the rear edge 184 of the tunnel barrier layer 50 is only exposed to ion milling to the extent necessary to mill through it. In a typical sensor stack, the antiferromagnetic layer 42 may actually be 10 or more times thicker than the other layers 46-62 of the sensor, such that the partial milling of the present invention includes an order of magnitude less milling time and material removal than in the prior art. The inventors have discovered that the milling damage that occurs in the prior art sensor 30 due to the extensive additional milling of the pinned magnetic layer 46 and antiferromagnetic layer 42 does not occur when the significantly reduced milling exposure of the rear edge 184 of the tunnel barrier layer 50 is performed in fabricating the sensor 150 of the present invention.

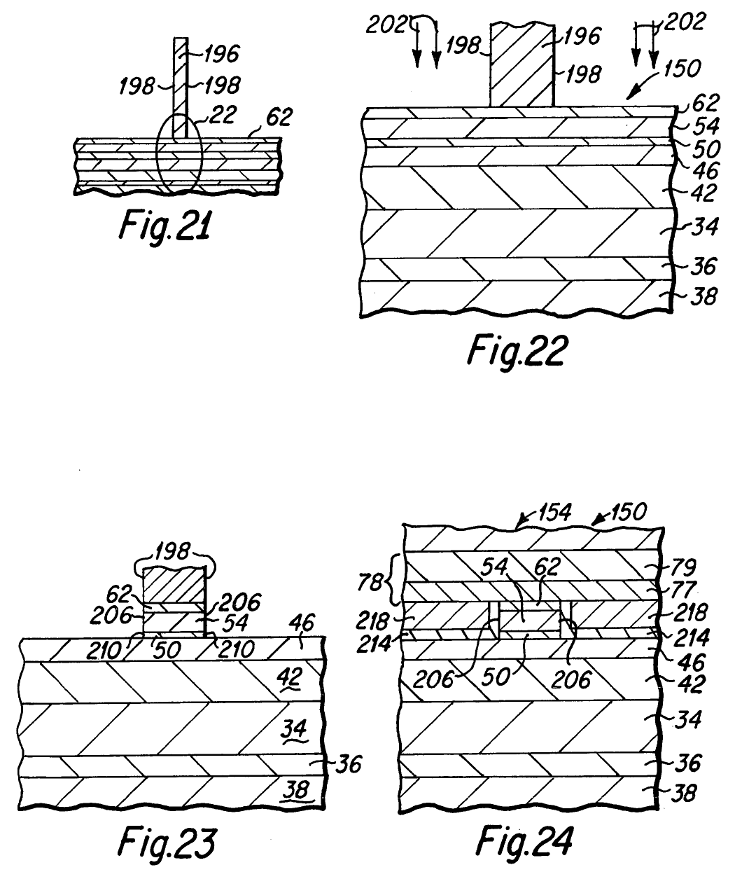

As is next depicted in FIGS. 20 and 21 (where FIG. 21 is taken along lines 21-21 of FIG. 20), a patterned fill layer 190, using a material such as alumina, is then deposited upon the wafer. Thereafter, another milling mask 194 is fabricated upon the sensor layers. The milling mask 194 may be substantially identical to the milling mask 120 described hereabove with the aid of FIGS. 9-11. As is seen in FIGS. 20 and 21, the milling mask 194 includes a narrow central mask portion 196 having side edges 198 that will serve to define the read width of the sensor. Thereafter, referring to FIG. 22 which is an enlarged view of the milling mask depicted in FIG. 21, another ion milling step using an ion beam 202 is performed to remove unmasked sensor layer material as is next shown in FIG. 23 to create the sensor side walls 206. Significantly, this ion milling step is performed to remove sensor layers only down through the tunnel barrier layer 50. The pinned magnetic layer material 46 and the antiferromagnetic layer material 42 are not milled away.

In comparison with the prior art sensor fabrication, as described hereabove with the aid of FIG. 12, it is not necessary in the present invention to mill away the pinned magnetic layer 46 and antiferromagnetic layer 42. Therefore, this milling step using the ion beam 202 which forms the side edges 210 of the tunnel barrier layer 50 does not involve the removal of the pinned magnetic layer 46 and antiferromagnetic layer 42. Thus, in Applicant's sensor 150, the side edges 210 of the tunnel barrier 50 are only exposed to ion milling to the extent necessary to mill through it. The milling damage that occurs in the prior art sensor 30 due to the extensive additional milling of the pinned magnetic layer and antiferromagnetic layer 42 does not occur when the significantly reduced milling exposure of the edges 210 of the tunnel barrier layer 50 is performed in the present invention.

Thereafter, as depicted in FIG. 24, an electrical insulation layer 214 is then deposited to cover the device, including the side walls 206 of the remaining sensor material. Hard bias elements 218 are next fabricated upon the insulation layer 214, and the second magnetic shield structure 78, which may include a non-magnetic material layer 77 and a magnetic material layer 79, is fabricated above the sensor layers 42-62 and hard bias elements 218.

Following the fabrication of the read sensor 150, further well known fabrication steps are undertaken to fabricate write head components (not shown) of a magnetic head 154 of the present invention. Thereafter, the wafer is sliced into rows of magnetic heads and the air bearing surface of the magnetic head is fabricated to establish the stripe height of the sensor 150; individual magnetic heads 154 suitable for installation within the hard disk drive 10 of the present invention are ultimately created. These further fabrication steps are well known to those skilled in the art.

It is therefore to be understood that the improved CPP read sensor 150 of the magnetic head 154 of the present invention is fabricated with partial milling steps that establish the back wall 176 and the side walls 206 of the sensor 150. The back edge 184 and side edges 210 of the tunnel barrier layer 50 are milled through, however the sensor material below the tunnel barrier layer 50, including the pinned magnetic layer 46 and antiferromagnetic layer 42 are not milled, such that milling damage to the back edge 184 and side edges 210 of the tunnel barrier layer 50 is minimized. In alternative embodiments, it is within the scope of the present invention that the partial milling be performed down through the pinned magnetic layer 46 and even into the antiferromagnetic layer 42. However, edge damage to the tunnel barrier layer 50 caused by the additional milling will tend to increase as the additional milling is performed.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

What we claim is:

1. A magnetic head, comprising:
a CPP read sensor including a plurality of sensor layers, wherein some of said sensor layers are formed with a back edge that defines a sensor stripe height, and wherein others of said sensor layers are not formed with a said back edge; and
wherein said plurality of sensor layers include an antiferromagnetic layer, where said antiferromagnetic layer does not have a said back edge.

2. A magnetic head as described in claim 1 wherein said plurality of sensor layers includes a pinned magnetic layer that does not have a said back edge.

3. A magnetic head as described in claim 1 wherein said plurality of sensor layers includes a tunnel barrier layer that does have a said back edge.

4. A magnetic head as described in claim 3 wherein said plurality of sensor layers includes a free magnetic layer that does have a said back edge.

5. A magnetic head as described in claim 1 wherein said some of said plurality of sensor layers are also formed with two side edges that define a read width, and wherein said antiferromagnetic layer does not have a said side edge.

6. A magnetic head as described in claim 5 wherein said plurality of sensor layers includes a pinned magnetic layer that does not have a said side edge.

7. A magnetic head as described in claim 5 wherein said plurality of sensor layers includes a tunnel barrier layer that does have two said side edges.

8. A magnetic head as described in claim 7 wherein said plurality of sensor layers includes a free magnetic layer that does have two said side edges.

9. A magnetic head comprising:
a CPP read sensor including a first magnetic shield, a second magnetic shield and a plurality of sensor layers that are disposed between said first magnetic shield and said second magnetic shield;
said plurality of sensor layers including an antiferromagnetic layer, a pinned magnetic layer, a tunnel barrier layer and a free magnetic layer;
wherein some of said sensor layers are formed with a back edge, two side edges and a front edge, and wherein a sensor stripe height is determined by the distance between said back edge and said front edge; and
wherein said antiferromagnetic layer does not include a said back edge, and wherein said tunnel barrier layer does include a said back edge.

10. A magnetic head as described in claim 9 wherein said pinned magnetic layer does not include a said back edge.

11. A magnetic head as described in claim 10 wherein said free magnetic layer does have a said back edge.

12. A magnetic head as described in claim 11 wherein said two side edges define a sensor read width, and wherein said antiferromagnetic layer does not include a said side edge, and said tunnel barrier layer does have two said side edges.

13. A magnetic head as described in claim 12 wherein said pinned magnetic layer does not have a said side edge.

14. A magnetic head as described in claim 12 wherein said free magnetic layer does have two said side edges.

15. A hard disk drive, comprising:
a rotatable hard disk;
a magnetic head being disposed for reading data from said hard disk, said magnetic head, including:
a CPP read sensor including a plurality of sensor layers, wherein some of said sensor layers are formed with a back edge that defines a sensor stripe height, and wherein others of said sensor layers are not formed with a said back edge; and
wherein said plurality of sensor layers include an antiferromagnetic layer, where said antiferromagnetic layer does not have a said back edge.

16. A hard disk drive as described in claim 15 wherein said plurality of sensor layers includes a pinned magnetic layer that does not have a said back edge.

17. A hard disk drive as described in claim 15 wherein said plurality of sensor layers includes a tunnel barrier layer that does have a said back edge.

18. A hard disk drive as described in claim 17 wherein said plurality of sensor layers includes a free magnetic layer that does have a said back edge.

19. A hard disk drive as described in claim 15 wherein said some of said plurality of sensor layers are also formed with two side edges that define a read width, and wherein said antiferromagnetic layer does not have a said side edge.

20. A hard disk drive as described in claim 19 wherein said plurality of sensor layers includes a pinned magnetic layer that does not have a said side edge.

21. A hard disk drive as described in claim 19 wherein said plurality of sensor layers includes a tunnel barrier layer that does have two said side edges.

22. A hard disk drive as described in claim 20 wherein said plurality of sensor layers includes a free magnetic layer that does have two said side edges.

23. A method for fabricating a magnetic head on a wafer substrate, comprising:
fabricating a CPP read sensor including:
depositing a plurality of sensor layers, including an antiferromagnetic layer, a pinned magnetic layer, a tunnel barrier layer and a free magnetic layer;
fabricating a first milling mask upon said sensor layers, said first milling mask being formed to cover a central portion of said sensor layers while not covering edge portions of the magnetic head and also not covering alignment marks disposed on the wafer substrate;
first milling unmasked portions of said sensor layers to expose said alignment marks;
fabricating a second milling mask upon said sensor layers, said second milling mask having a back edge that is disposed to form a back edge of some of said sensor layers;
second milling unmasked portions of some of said sensor layers to create a back edge of some of said sensor layers, wherein said antiferromagnetic layer is not milled in this second milling.

24. A method for fabricating a magnetic head as described in claim 23 wherein said pinned magnetic layer is not milled in said second milling.

25. A method for fabricating a magnetic head as described in claim 23 wherein said tunnel barrier layer is milled in said second milling to create a said back edge thereof.

26. A method for fabricating a magnetic head as described in claim 23 including fabricating a further milling mask upon said plurality of sensor layers, said further milling mask having two side edges that are disposed to form two side edges of some of said plurality of sensor layers;
third milling unmasked portions of some of said sensor layers to create two side edges of some of said sensor layers;
wherein said antiferromagnetic layer is not milled in this third milling.

27. A method for fabricating a magnetic head as described in claim 26 wherein said pinned magnetic layer is not milled in said third milling.

28. A method for fabricating a magnetic head as described in claim 26 wherein said tunnel barrier layer is milled in said third milling to create two said side edges thereof.
